(19) United States
(12) Patent Application Publication
(10) Pub. No.: US 2007/0240554 A1
(43) Pub. Date: Oct. 18, 2007

(54) Musical tuning switcher

(76) Inventor: Juan Pablo Hany, Palm Springs, CA (US)

Correspondence Address: Juan Pablo Hany, Apto. # 18, 2900 E. Ramon Rd., Palm Springs, CA, 92264, US

(21) Appl. No.: 11/406,701

(22) Filed: Apr. 18, 2006

(51) Int. Cl. G10D 3/14

(52) U.S. Cl. 84/312 R

(57) ABSTRACT

The invention is an attachable string tension control device for adjusting individually and simultaneously the pitch of each and every string of a plurality of strings of a musical instrument, wherein said strings are pre-tensioned between two critical contact points. The attachable string tension control device is comprised of a base for supporting the following components: a roller assembly for receiving the strings, and an adjustable pulleys assembly for adjusting individually the height of each string, and a string holding assembly for preventing the lose of tension of the strings. At a position between the adjustable pulleys assembly and string holding assembly there is a shaft rotatably connected to the base for supporting a plurality of adjustable cams for applying tension to the strings when rotated, said shaft having a handle at one of its ends (NOT SHOWN). Each of the cams including a pulley for decreasing the friction between the strings and said cams. Also the attachable string tension control device including a shaft locking assembly for stopping and releasing the rotation of the shaft at a determined position. The attachable string tension control device is operable to independently and simultaneously modify the tune of each and every string of a plurality of strings of a stringed musical instrument, allowing an operator to switch instantly between a variety of preselected tunings. The tuning system of the present invention is useful with respect to a wide variety of stringed musical instruments such as, guitars, basses, etc., and other instruments.

### CROSS-REFERENCE TO RELATED APPLICATIONS

Not Applicable

### FEDERALLY SPONSORED RESEARCH

Not Applicable

### SEQUENCE LISTING OR PROGRAM

Not Application

### BACKGROUND OF THE INVENTION

1. Field of the Invention

The present invention relates to multiple string tension switching devices for stringed musical instruments such as guitars. Specifically the type of devices used to adjust individually and simultaneously the pitch of each string of a plurality of strings of a musical instrument.

2. Prior Art

As is well known, guitars are popular musical instrument worldwide. A guitar can be tuned in Standard Tuning, which is the most common tuning, and Alternative Tunings.

Among other reasons, Alternative Tunings are created to enable otherwise-unplayable musical arrangements.

When the pitch of one or more strings of a guitar differs from Standard Tuning an Alternative Tuning is created.

Changing manually the tuning of the strings of a guitar can be a time-consuming process, especially when this change requires the change of more than one string pitch.

For example:

Changing from Standard Tuning (E-A-D-G-B-E) to Open Gm (D-G-D-G-A#-D).

In this case four strings decrease their tension.

This change requires changing the pitch of four strings. Besides, a guitar player has to learn new scale positions to play melodies in a guitar tuned in an Alternative Tuning.

It is very difficult if not impossible in some cases to change the tuning of a guitar in the middle of a song, especially given the sophistication of today's live audiences, who can sense an out of tune string on a guitar.

Therefore, musicians are limited if the tuning configuration of the strings of a musical instrument such as a guitar can not be changed quickly and efficiently.

Inventors created several types of systems to resolve this problem, for example:

The tuning device in U.S. Pat. No. 2,603,119 to Ronald E. Dearth, Jul. 15, 1952 discloses a gross general design and poor adjusting means, which just add more problems.

The apparatus in U.S. Pat. No. 6,023,014 to Sperzel; Robert J., Feb. 8, 2000 as many apparatus in the same kind had a limited use because the pitch of each string had to be changed individually. An apparatus and method for self-tuning stringed musical instruments with an accompanying vibrato mechanism disclosed in patent application 2006059037459 to Skinn; Neil; et al., Feb. 23, 2006.is a too complex, slow and expensive system. Also the system is heavy and the musical instrument has to be built specifically for this tuning system or adapted, which will comprise irreversible changes to a guitar that will not work without the said system. The apparatus in U.S. Pat. No. 2,949,806 to Thomas B. Turman, Aug. 23, 1960 is an individual string tone changer and does not solve the problem in question.

Here there is a list of some of the most relevant systems:

U.S. Pat. No. 5,438,902 Baker, Aug. 8, 1995.

U.S. Pat. No. 5,528,970 Zacaroli, Jun. 25, 1996.

U.S. Pat. No. 5,767,429 Milano, et al., Jun. 16, 1998.

U.S. Pat. No. 6,806,411 Allen, Oct. 19, 2004.

U.S. Pat. No. 6,184,450 LeBlanc, Feb. 6, 2001.

U.S. Pat. No. 5,986,190 Wolff, et al., Nov. 16, 1999.

U.S. Pat. No. 5,696,335 Rose, Dec. 9, 1997.

U.S. Pat. No. 5,589,653 Rose, Dec. 31, 1996.

U.S. Pat. No. 4,882,967 Rose, Nov. 28, 1989.

U.S. Pat. No. 4,686,883 Piche, et al. Aug. 18, 1987.

U.S. Pat. No. 4,170,161 Kaftan, Oct. 9, 1979.

U.S. Pat. No. 4,878,413 Steinberger*, Nov. 7, 1989.

U.S. Pat. No. 5,886,270 Wynn, Mar. 23, 1999.

Many inventors have approached this problem, but all the related inventions heretofore known suffer at least of one of the following disadvantages:
(a) Their structures and stiles are heavy, gross, and impractical for today's musician's needs.
(b) Their systems are too complex to get the desired result quickly and efficiently.
(c) Their adjustment means are deficient because they are difficult to control and access.
(d) They are not reliable and accurate because their inventors did not succeed on solving other issues about the problem in discussion, as wearing, friction, and correct sliding of the parts of the apparatus and the strings to obtain a desire and precise result.

### OBJECTIVES AND ADVANTAGES

Accordingly, several objectives and advantages of the “Musical Tuning Switcher” are:
(a) To provide a tuning system which will be operable to make changes to the tuning of a musical instrument such as a guitar quickly and efficiently.
(b) To provide a tuning system which will change independently and simultaneously the pitch of each and every string of a plurality of strings of stringed musical instruments.
(c) To provide a tuning system whose production is inexpensive, fast, and easy.
(d) To provide a tuning system which will be less complex and more adjustable to almost any type of guitar.
e) To provide a tuning system whose appearance is pleasant and its style is customizable.
(f) To provide a tuning system which will present a superior range of tuning adjustments.
(g) To provide a tuning system which will be small, light, and durable.
(h) To provide a tuning system which will be accurate and easy to use.
(i) To provide a higher quality tuning system which will be accessible to a bigger market due to its low cost production.

Further objectives and advantages will become apparent from a consideration of the ensuing description and drawings.

### SUMMARY

The tuning system comprises a housing which holds a plurality of string tension and string height adjustment elements, an attaching system to attach the tuning system to a musical instrument, and a clamping system, and a shaft having a handle (NOT SHOWN) at one of its ends for connecting the manual force applied to it to the string tension elements and other parts of the system.

### DRAWING—FIGURES

The drawings of the system of the present invention show some of the pieces of the complete system, allowing a better interpretation of the figures, but it is understood that the system will need the required amount of pieces to work correctly.

FIG. 1; is a left side cross-section view of the “Musical Tuning Switcher” taken generally on the line 6-6 of FIG. 8. This figure shows some of the internal parts of the system and the pass of the string of the musical instrument through said system.

FIG. 2; is a left side cross-section view of the attachable device taken generally on the line 2-2 of FIG. 8. This figure shows in detail the position en relation of the Lever 154, the magnetized lever stoppers 157, the half way threaded rod 214, the recess on the shaft 216, etc.

FIG. 3; is a left side plan view of the attachable device showing the lateral wall (a) 234.

FIG. 4 is a front plan view of the attachable device shown in FIG. 3.

FIG. 5 is top plan view of the attachable device shown in FIG. 3.

FIG. 6 is a left side cross-section view of the attachable device taken generally on the line 6-6 of FIG. 8 as the FIG. 1. This figure shows some of the internal parts of the system in detail.

FIG. 7 is a left side cross-section view of the attachable device taken generally on the line 7-7 of FIG. 9.

FIG. 8 is a the same view of FIG. 4 showing the cut line 6-6 and 2-2.

FIG. 9 is a the same view of FIG. 5 showing the cut line 7-7.

### DRAWINGS—REFERENCE NUMERALS

100 String.
110 Base.
111 Hole for the lever axle.
112 Bearing hole.
114 Shaft.
116 Holding system.
118 Inferior part of holding device (inferior jaw).
122 Superior part of holding device (superior jaws).
124 Hole of the superior part of holding device.
126 Attachment system.
127 Attachment system threaded hole.
128 Attachment system screw.
130 First slot of the cam to access the shaft threaded hole.
132 Second slot of the cam to attach the pulley by its nut.
134 Cam (irregularly-shaped element).
142 Pulley (a) (adjustable contact elements).
144 Pulley (b).
147 Nut.
152 Arm (a) of the lever. (first arm).
153 Arm (b) of the lever. (second arm).
154 Lever.
157 Magnetized lever stoppers.
158 Axle of the rollers.
162 Screw of the holding device.
166 Nut of the roll.
182 Screw of the shaft.
194 Axle of the lever.
210 Threaded hole in the shaft.
214 Half way threaded rod.
216 Recess on the shaft.
218 Threaded hole in the shaft for the threaded rod.
224 Roller.
226 Roller spacers.
227 Rigid arms.
230 Cutting slots for the pulleys (b).
232 Cutting slot (a) for the axle of the rollers.
233 Cutting slot (b) for the axle of the rollers.
234 Lateral wall (a).
236 Lateral wall (b).

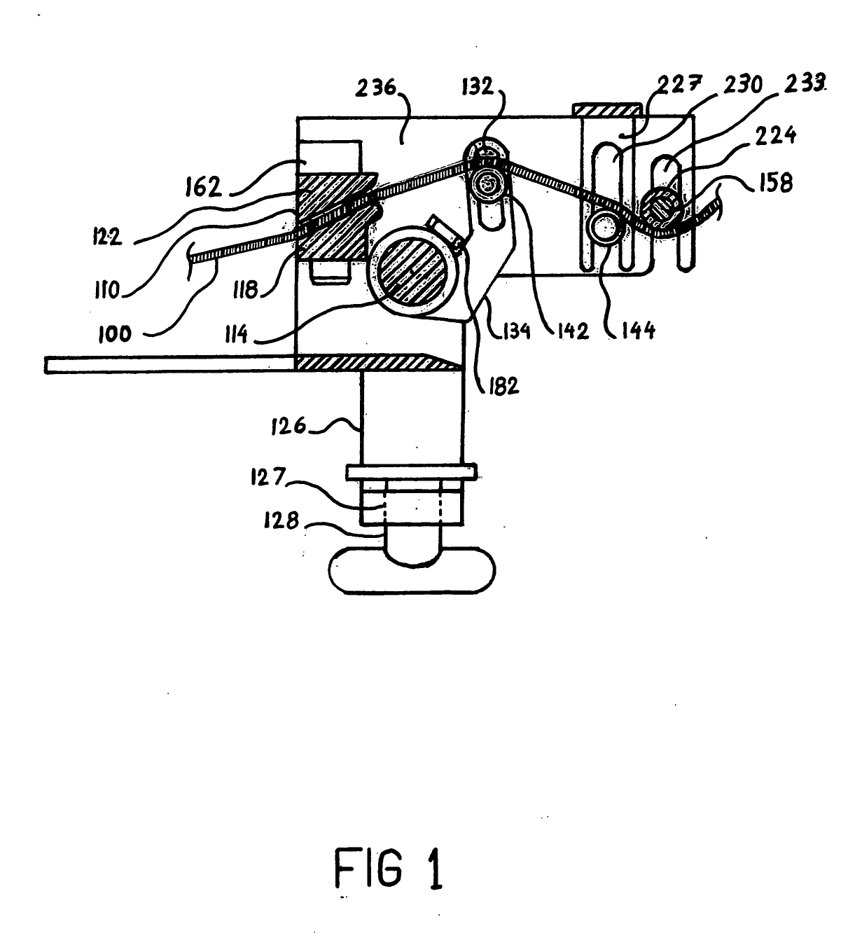

### DETAILED DESCRIPTION—FIGS. 1, 2, AND 3—PREFERRED EMBODIMENT

Some of the elements described here are the necessary elements for one string, but is understood that for a plurality of strings, it will be required also a plurality of elements respectively.

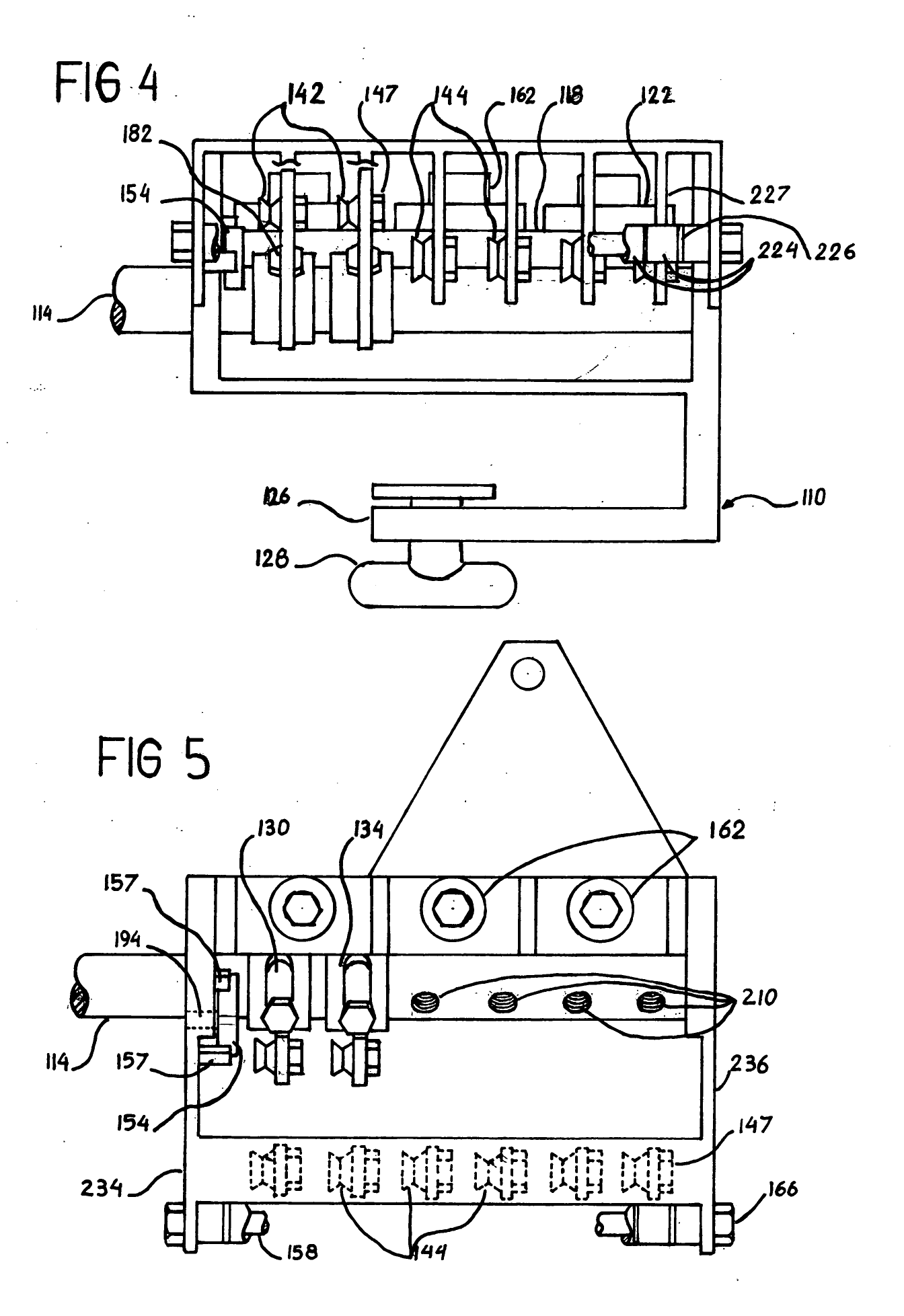

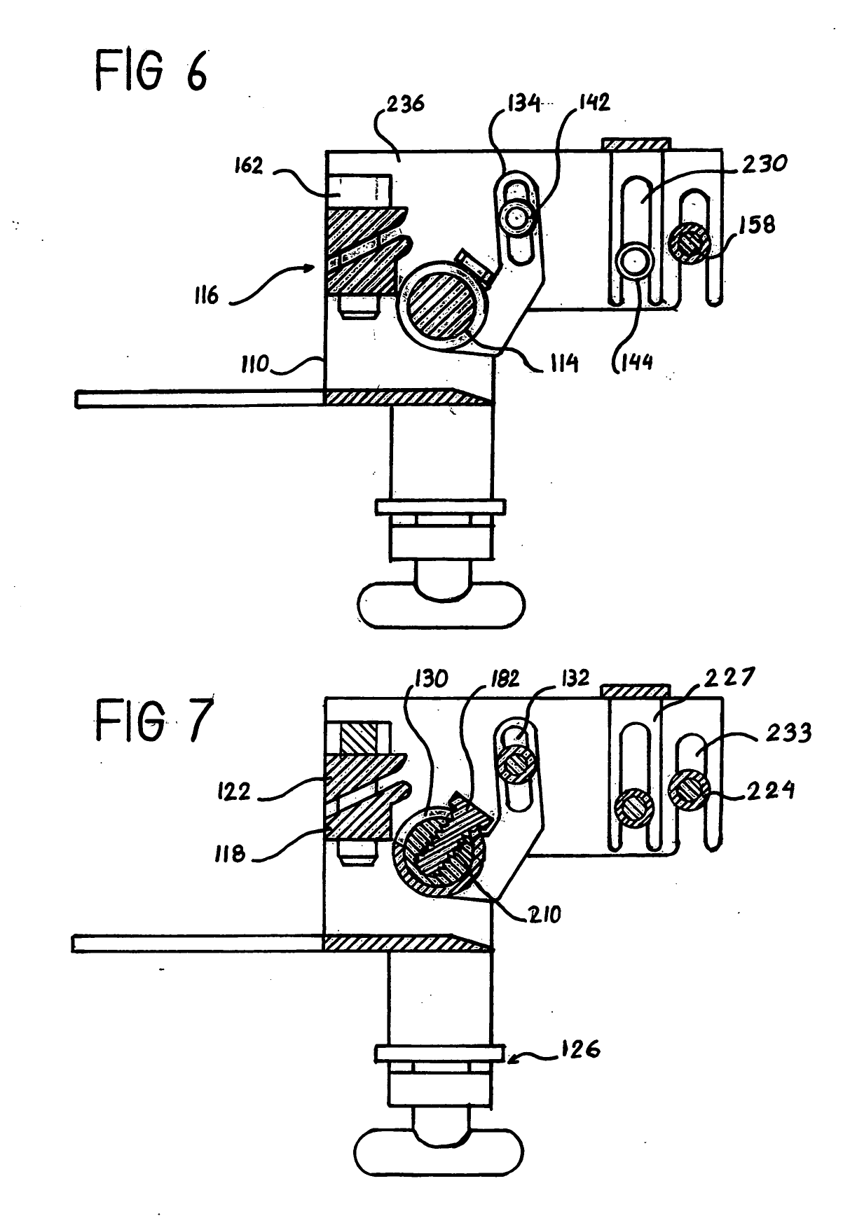

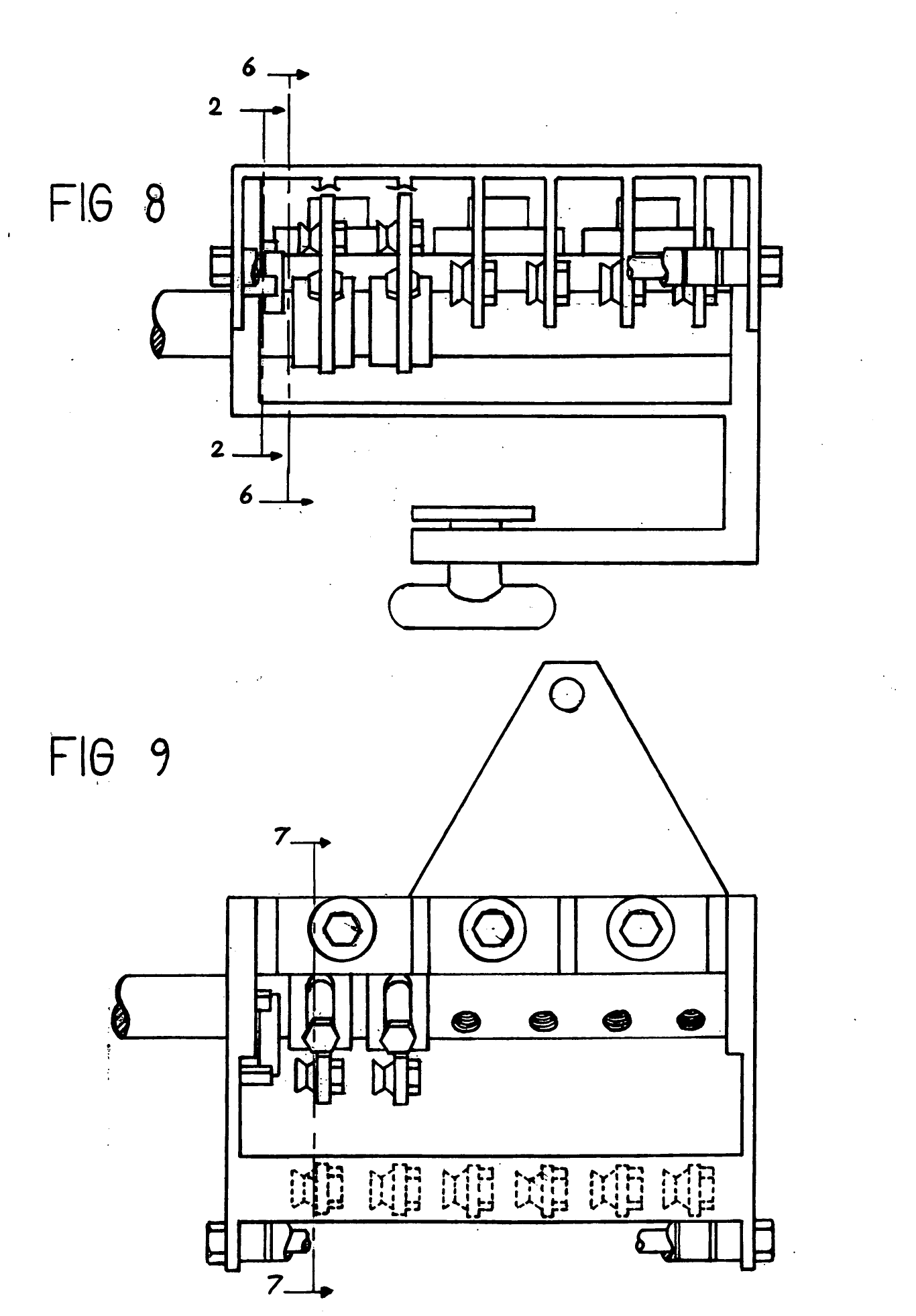

A preferred embodiment for the system of the present invention is illustrated in the drawings. As seen in FIG. 4 a base 110, supports a plurality of tension control elements, and has an integrated attachment system 126, and a holding system 116.

Said base 110 has two lateral walls, wall (a) 234 and wall (c) 326 FIG. 5. Each wall has a cutting slot, first cutting slot (a) 232 and cutting slot (b) 233 FIG. 3 and FIG. 1. Also each wall has a bearing hole 112 and the wall (a) also has a hole 111 FIG. 3.

The holding system comprises of: an inferior part 118 (inferior jaw), a superior part 122 (superior jaw), and a plurality of screws 162 (threaded fasteners).

The superior part 122 has holes 124. The inferior part 118 has threaded holes (NOT SHOWN). Each screw 162 pass through each of the holes 124 in the superior part and through each threaded hole (NOT SHOWN) in the inferior part respectively.

Holding system 116 parts are made of steel.

The holding system's inferior part 118 is integrally connected to the base 110, but other means of connection such as screws can be used.

The plurality of string tension controllers supported by the base 110 are listed in great detail bellow.

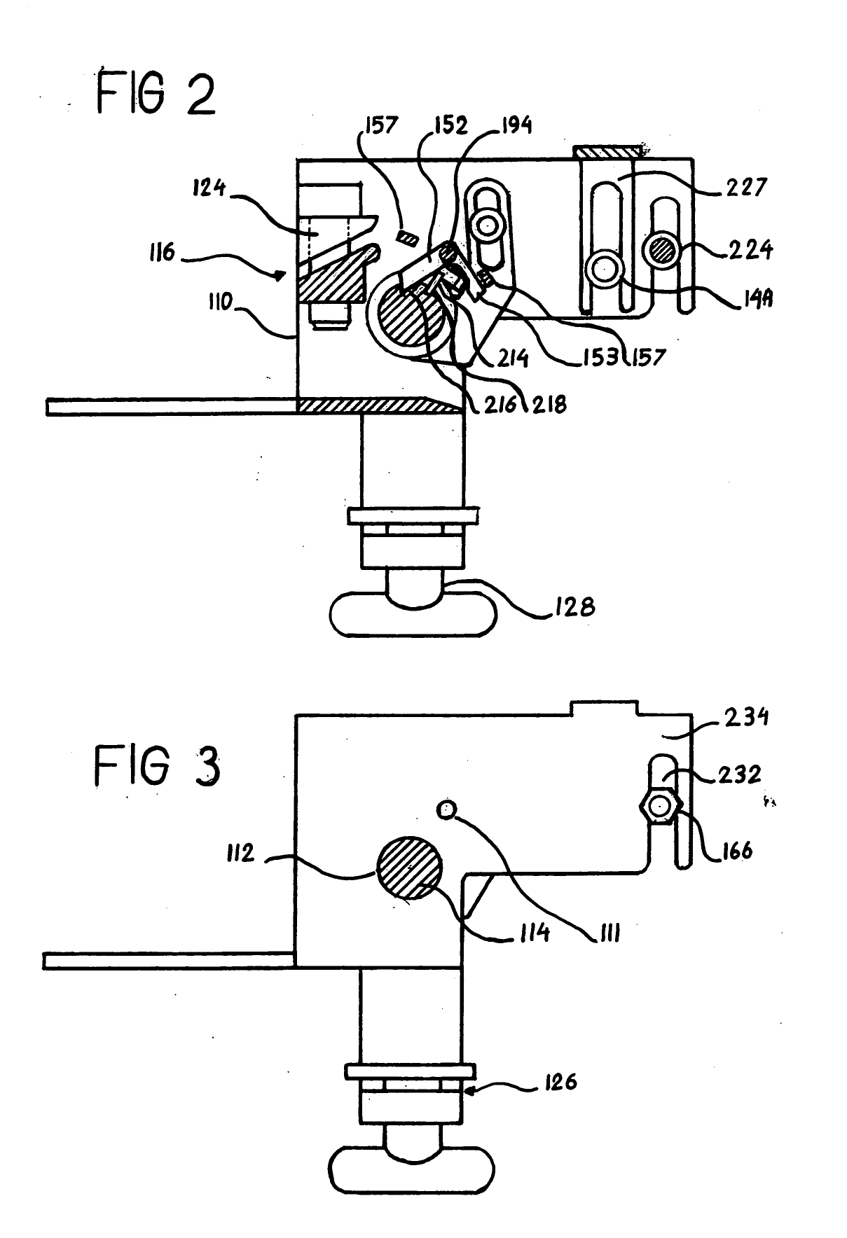

As shown in FIG. 2 a shaft 114 supports a cam 134 (irregularly-shaped element) and a half way threaded rod 214 (activator).

The shaft 114 has a plurality of treaded holes 210 FIG. 5, and a hole 218 FIG. 2.

The cam 134 has a pulley (a) 142 (adjustable contact element), and two slots, slot 130 (first slot) and slot 132 (second slot) FIG. 7. Said pulley (a) 142 having a threaded axle (not shown) and a nut 147 to connect to the slot 132 of the cam 134 FIG. 4.

A screw 182 (treaded fastener) connects the cam 134 to the shaft 110 through the slot 130 and through one of the threaded holes 210 FIG. 9.

The half way threaded rod 214 is screwed to the threaded hole 218 of the shaft 114 FIG. 2.

The shaft 114 is connected to the base 110 through the bearings holes 112 FIG. 3.

An “L” shaped lever 154, has two arms, arm (a) 152 (first arm) and arm (b) 153 (second arm), and an axle 194 (FIG. 2) rotatably connected to the lateral wall (a) through a hole 111 (FIG. 3).

Two magnetized lever stoppers 157, stopper (a) and stopper (b) which are located at the wall (a) limiting and assisting the rotation of the lever 154 (FIG. 5).

The line of rotation of the rod 214 is aligned with the line of rotation of the lever 154 in a manner in which the rod 214 affects the lever's arms (a) 152 and 153 (b) when rotated (FIG. 5). A recess 216 on the shaft 114 at a position where the line of rotation of said recess 216 is aligned with lines of rotation of the lever 154 and the rod 214, in a manner in which the recess interact with the lever arm (a) 153 (FIGS. 2, 5, and 4).

I presently prefer the magnetized lever stoppers 157, however two un-magnetized stoppers can be used in the same spots of the magnetized lever stoppers 157 instead, to limit the rotation of the lever, and a spring (NOT SHOWN) connected to the lever 154 and the lateral wall (a) 234 to assist the movement of said lever 152.

The lever is made of steel, however other tough metal can be used.

A height adjusting system comprised of a plurality of rigid arms 227 in a row located between the lateral walls (a) and (b) of the base 110, where each rigid arm 227 has a cutting slot 230 for holding a adjustable pulley (b) 144 (FIG. 5). The line of rotation of said pulley (b) 144 is aligned with the line of rotation of the pulley (a) 142 (FIG. 9).

An axle 158 having a plurality of rollers 224 and roller spacers 226 is connected to the base lateral walls (a) and (b) through the cutting slot (a) 232 and (b) 233, best shown in FIGS. 1, 3, and 5). The pulleys (b) 144 have threaded axles (Not SHOWN) and nuts 147 to connect said axle to the cutting slots 230 (FIG. 4).

All movable parts are made of steel, however other tough metal may be used.

The attachment system, best shown in FIGS. 2 and 3 is comprised of an “L” shaped body having a threaded hole 127, and a screw 128 (FIGS. 1 and 4). Said screw having flat washer-like tip and a “T” shape head. The screw 128 is connected to the “L” shaped body through the threaded hole 127.

The attachment system is integrally connected to the base 110 but it can be connected by screws or by other means.

The attachment system body is made of aluminum as the rest of the base, it also can be made of other tough metals. The screw 128 is made of steel.

The pieces shown in the figures are for illustrative purposes, but it will be understood that the quantity of them will be increased as required by the desired tuning and the quantity of strings of the musical instrument involved.

Operation—FIGS. 1, 2, 3, 4, 5 and 7

Some of the elements described here are the necessary elements for one string, but is understood that for a plurality of strings, it will be required also a plurality of elements respectively.

The manner of operating the Musical Tuning Switcher will be described in detail bellow. The Musical Tuning Switcher is attached to a musical instrument, in this case a guitar. the tuning system is attached between the pegs and the end of the neck of said guitar by the attachment system 226.

The string of the guitar passes through the tuning system making contact with the following contact points:

(a) underneath the rollers 224, and

(b) over the pulley 144 attached to the cutting slot 227, and

(c) over the pulley 142 attached to the cutting slot 132 of the cam 134, and

(d) between the superior 122 and inferior 118 parts of the string holding system.

The function of the holding system 116 is to ensure accuracy when tension is applied to the strings.

The function of the shaft 114 and cam 134 is apply tension to the strings.

The function of the pulley (a) 142 of the cam is to provide a rotating point of contact reducing friction when the cam 134 applies tension to the string.

The function of the pulley (b) 144 connected to the cutting slot 230 is to get the string further from or closer to the range of operatively of the cam 134.

The function of the rollers 224 is to keep the string touching the bridge at the end of the fingerboard of the musical instrument such as a guitar.

The function of the lever 154 is to stop and release the rotation of the shaft 114 in a fixed position.

When the lever 154 stops the rotation of the shaft, consequently the cam 134 connected to the shaft 114 is stopped too. These movements raise the tension of the string and keep it constant. When the lever 154 releases the shaft 114 the string pushes the cam 134 downwards. Let's suppose we want to change the tuning of one string only.

For example, we will raise the pitch of the first string from “Mi” (E) to “Fa” (F).

Is understood that the attachable device is previously adjusted to get the desired result.
Changing the tuning. (raising the pitch)
(a) Turning the handle (not shown) connected to the shaft 114 upwards. The cam 134 and the rod 214 are connected to the shaft, and consequently are moved upwards too.
(b) The pulley 142 of the cam 134 presses the string upwards increasing its tension and by consequence raising its pitch.
(c) The string slides over and under the pulleys (a) and (b) and the roller 224 respectively as is tensioned.
(d) The pulleys and rollers rotate avoiding friction.
(e) The lever's arm (a) 152 fits in the recess 216 of the shaft keeping the shaft 114 and the cam 134 from rotating downwards and consequently keeping constant the tension applied to the string. The tension applied to the string has raised the pitch of said string from “Mi” (E) to “Fa” (F). Now let's return the string to its early pitch, “Mi” (E).

Returning to the early tuning. (decreasing the pitch)
(a) Turning the shaft 114 upwards again a bit more the string gets a bit more tension.
(b) The rod 214 connected to the shaft 114 pushes the lever arm (a) 152 forcing it to release the shaft.
(c) The string pushes the cam 134 downwards and by consequence the shaft 114 rotates downwards too.
(d) The string its looses tension sliding over and under the pulleys and rollers respectively.
(e) The rod 214 connected to the shaft 114 pushes the arm (b) 153 of the lever 154 and the magnetized lever stoppers 157 assist this movement.

Now the lever 154 is ready to stop the shaft 114 again in a fixed point when it is turned upwards.

The string has returned to its early pitch.

Now let's suppose we want to apply more tension to the string.

In this case we will have to adjust the height of the pulleys (b) 144.

The function of the rollers is to keep the string touching the bridge at the end of the neck of the guitar, so we do not need to adjust the roller.

What we can do is decrease the height of the pulley (b) 144 to bring the string closer to the range of operability of the cam 134, so the cam 134 will apply more tension to the string.

By loosening the nut of the pulley its height can be adjusted easily.

We can also adjust the cam rotation by loosening the screw which connects cam 134 with the shaft 114 and adjust position of said cam 134 with respect to said shaft 114.

Now the string is lower and the rotation of the cam will affect the string tension more.

Lets suppose we want to apply even more tension to the string. In this case we will have to increase the length between the center of rotation of the cam 134 and the pulley (a) 142 of said cam.

If we want to do the opposite adjustments to the string, the process is the opposite too. All these possible adjustments in conjunction open a huge field of possibilities.

### CONCLUSION, RAMIFICATION, AND SCOPE OF THE INVENTION

Thus the reader will see that the “Musical Tuning Switcher” is an attachable device for adjusting individually and simultaneously the pitch of each string of a plurality of strings of musical instrument.

The “Musical Tuning Switcher” provides a highly reliable, lightweight, less complex, more adjustable yet economical system that can be used by musicians of any level.

While my above description contains many specificities, these should not be construed as limitations on the scope of the invention, but rather as examples of the preferred embodiment thereof. Many other variations are possible, for example; the tuning system may be attached to the body of the guitar, or the cam may have different adjustment means to control the rotation, etc.

Accordingly, the scope of the invention should be determined not by the embodiments illustrated but by the appended claims and their legal equivalents.

What is claimed is:

1. an attachable device for adjusting individually, simultaneously and instantly the pitch of each and every string of a plurality of strings of a musical instrument, wherein said strings are pre-tensioned between two critical contact points, comprising of:
(a) a base attached proximate to one of the two critical contact points, and
(b) a first means for adjusting independently and simultaneously the tension of each string of said plurality of strings, rotatably connected to said base, and
(c) a second means for keeping the strings from loosening tension when tension is applied to them, said second means is connected to the base, and whereby the attachable device of claim 1 can be attached to a musical instrument for modifying independently and simultaneously the tuning of the strings, consequently the musical instrument can offer instant access to a diverse plurality of tunings.

2. The attachable device as set forth in claim 1 wherein said first means for adjusting independently and simultaneously the tension of each string, comprises a plurality of irregularly-shaped elements rotatably mounted and longitudinally aligned with the strings for applying tension to said strings when rotated.

3. The attachable device as set forth in claim 2 further including a third means for attaching said attachable devise to said musical instrument.

4. The attachable device as set forth in claim 3 wherein each of said irregularly-shaped elements comprises:
(a) an irregularly shaped flat body showing a right and left side and having a hollowed center showing an interior and exterior portion, and
(b) a first slot in the closest portion to the hollowed center creating a pass-way between the interior and the exterior portion of the body, and
(c) a second slot in the farthest portion from the hollowed center connecting the right side with the left side of said body.

5. The attachable device as set forth in claim 4 wherein said second means comprises:
(a) a plurality of movable superior jaws, each having a hole for connecting purposes, and
(b) an inferior jaw having threaded holes, integrally connected to the base, and
(c) a plurality of threaded fastener for connecting and securing the movable superior jaws to the inferior jaw by passing through the holes of the movable superior jaws and screwing in the threaded holes of the inferior jaw in a manner in which the end of each string can pass through and be secured between said inferior and superior jaws.

6. The attachable device as set forth in claim 5 further including a plurality of adjustable contact elements rotatably connected to the second slot of each one of the irregularly-shaped elements for reducing the friction between the strings and said irregularly-shaped elements when said irregularly-shaped elements are rotated, wherein the length between the center of rotation of said irregularly-shaped element and center of rotation of the adjustable contact elements can be adjusted by moving said contact element along the length of the second slot to increase or decrease the range of operability of said irregularly-shaped element.

7. The attachable device as set forth in claim 6 further including a shaft rotatably mounted to the base and transversally positioned with respect to the strings, having a plurality of threaded holes and further including a plurality of threaded fasteners, wherein the shaft is rotatably connected to the irregularly-shaped elements by the hollowed centers of said irregularly-shaped elements and the threaded fasteners pass through the first slots of each irregularly-shaped elements and screw in the threaded holes of the shaft for securing the irregularly-shaped elements to the shaft and adjusting the range of operability of said irregularly-shaped elements.

8. The attachable device as set forth in claim 7 further including a forth means for stopping and releasing the shaft rotation, comprising:
(a) a lever having a first and a second arm and an axle rotatably connected to the base, and
(b) an activator fixed to the shaft for pushing the first or the second arm respectively for stopping and releasing the rotation of the shaft, and
(c) a plurality of magnetized lever stopper connected to the base for assisting the functions of stopping and releasing,
whereby the forth means for stopping and releasing the shaft stops and releases the shaft rotation at a determined position, determining the range of operability of said shaft and the plurality of irregularly-shaped elements connected to said shaft consequently.

9. The attachable device as set forth in claim 8 further including a fifth means for adjusting independently the height of each strings of the musical instrument, comprising:
(a) a plurality of rigid arms in a row connected to the base, located between the shaft and the closer critical contact point where the strings are pre-tensioned, and
(b) each rigid arm has a cutting slot,
(c) a plurality of contact elements, each rotatably connected to the cutting slot of each rigid arm.

10. The attachable device as set forth in claim 9 wherein said shaft has two extremes and one of said extremes projecting out of the base for easy access.

11. The attachable device as set forth in claim 10 further including a handle securely connected to the extreme of the shaft that is projected out of the base, whereby the tension of the strings is modified by rotary motion applied to the shaft, and said handle attached to said shaft facilitates the manual control of the attachable device.

12. A tuning apparatus for adjusting the tuning of stringed musical instruments having a plurality of musical strings, wherein said strings are pre-tensioned between two critical contact points, comprising:
(a) a base having a first means for attachment to said musical instrument, and
(b) a second means for controlling independently the tension of each string, said second means is connected to the base, and
(c) a third means for holding the strings, said third means connected to the base,
whereby an operator using the tuning apparatus connected to a stringed musical instrument such as a guitar can switch instantly between a determined quantity of tunings.

13. The tuning apparatus of claim 12 wherein the second means further includes:
(a) a shaft rotatably mounted to the base and transversally positioned with respect to the strings, and
(c) a plurality of cams, each rotatably connected to said shaft, and
(d) a plurality of pulleys wherein each pulley is rotatably and adjustably connected to each cam.

14. The tuning apparatus as set forth in claim 13 further including a fourth means for adjusting the height of each string of the plurality of strings, connected to the base.

15. The tuning apparatus of claim 14 further including a fifth means for stopping, holding and releasing the shaft at a predetermined position, said fifth means rotatably connected to the base.

16. A method of adjusting individually, simultaneously and instantly the pitch of every string of a plurality of strings of a stringed musical instrument such as a guitar, wherein said strings are pre-tensioned between two critical contact points, comprising:
(a) providing an attachable string tension control device, and
(b) providing a stringed musical instrument, and
(c) attaching said attachable string tension control device to said musical instrument outside the two critical contact points, in a manner in which said attachable string tension control device will affect the tension of the strings independently and simultaneously,
whereby an operator can use the provided attachable string tension control device for instantly changing the tuning of said stringed musical instrument.

17. The method of claim 16, further including:
(a) passing the strings of said musical instrument through and tuning said strings at the lowest tuning you desire to use, using the musical instrument's own tuning system,
(b) securing the plurality of strings to the attachable string tension control device, and
(c) adjusting the string tension control device to select a desired new tuning to be applied to the strings, and
(d) applying the new tuning to the strings, and the tension control device will hold the new tuning, and
(e) releasing the tension applied to the strings using the attachable string tension control device, allowing the strings to return to their previous tuning, whereby using this method the attachable string tension controller device will change the tuning of the musical instrument by applying independently and simultaneously tension to said strings.

18. The method of claim 17 wherein the base of the tension control device is made of a aluminum or other materials having the same characteristics.

19. The method of claim 18 wherein all the movable and adjustable pieces belonging to the attachable string tension control device are made of steel or other materials having the characteristics of being tough and resistant to deterioration due to friction and tension.
